(19) United States
(12) Patent Application Publication
(10) Pub. No.: US 2006/0204164 A1
(43) Pub. Date: Sep. 14, 2006

(54) Low cost fiber-optic gage and associated multi-channel all-optical data collecting system

(76) Inventor: Gennadii Ivtsenkov, Hamilton (CA)

Correspondence Address: GENNADII IVTSENDOV, 386 REXFORD DRIVE, HAMILTON, ON, L8W3Y7, CA

(21) Appl. No.: 11/163,917

(22) Filed: Nov. 3, 2005

Related U.S. Application Data
(60) Provisional application No. 60/594,064, filed on Mar. 8, 2005.

(51) Int. Cl. G02B 6/00; G02B 6/42; G01J 1/04; G02B 6/26

(52) U.S. Cl. 385/12; 385/13; 385/31; 385/32; 250/227.14

(57) ABSTRACT

Simplified and insensitive to ambient condition fiber-optic gage and associated multi-channel data collecting system capable of all-optical measurements of a physical phenomenon, such as gas and liquid pressure, temperature, structural movement and force without fire and explosion hazards associated with conventional strain gage technologies, such as resistance foil strain gages. The gage houses a sensitive element—a length of single-mode optic fiber and a bending device converting the measured phenomenon into specific bending of the optic fiber. Here, amplitude of a single-mode light passing the gage experiences variation under this specific mechanical bending applied to the sensitive element of the gage. A multi-channel time-division multiplexing data collecting system that includes another object of this invention—a single-mode fiber-optic switch. The invention may be embodied to measure any phenomenon that can be converted into the bending of a single-mode optical fiber.

### FIELD OF THE INVENTION

The present invention relates to the measurement of physical phenomena, such as pressure, temperature, structural movement and force by fiber-optic gage utilizing the effect of light attenuation under bending of an optic fiber. More particularly, the invention pertains to utilize the specific bending of single-mode optical fiber-radial stretching of circular coil of optic fiber and winding the fiber around fixed-radius shaft with controllable arc angle of the winding. The present invention also relates to associated multi-channel single-mode fiber-optical data collecting system and its elements, such as a fiber-optic switch, which allows all-optical remote monitoring.

### BACKGROUND OF THE INVENTION

This application is the corresponding non-provisional one related to the provisional application No. 60/594,064 filed Mar. 8, 2005.

Fiber-optic sensors successfully substitute now conventional resistance strain gages that have been the most widely used in the past, and are the most readily available technology at this time. The sensitive element of a fiber-optic gage is a length of specially prepared optic fiber that alter the transmitted optical signal in a manner that can be detected and measured by optical instrumentation when the fiber is mechanically affected.

This optical sensor technology has overcome many of the inherent disadvantages of resistance strain gages and its electrical transmission networks, including long-term measurement drift, sensitivity to electromagnetic interference, and dangers from electrical power requirements, which have limited their application in certain fields, such as fire and explosion hazardous environments.

Within the past two decades, a number of manufacturers have attempted to exploit the fiber-optic sensor technology, with limited results. The costs and complexity associated with the electronic and optical systems required to implement the fiber-optic gages were prohibitively high for most applications. Also, affect of ambient conditions, such as temperature, vibration, etc. on gage characteristics made these gages unreliable. Therefore, successful implementation of fiber-optic gages requires a novel approach that will allow simplifying the gage and associated data collecting system designs. There are a few principles that are now utilized in strain fiber-optic sensors:
Fiber Bragg grating. It is the most developed technology used for fiber-optic stress sensors. Here, the single-mode optical fiber with written Bragg grating is stretched by external force. It causes deviation of grating period that can be measured. For example, if a tensile force of 1 kg is applied to standard single-mode 9/125 optical fiber, it will be stretched on 0.82% that shifts the light wavelength reflected from the grating on 39 nm at 1550 nm. There are varieties of measuring technology that allow measuring such wavelength deviation. In some designs, such fiber sensors have doubled or tripled grating and utilize scanning multi-wavelength light source to achieve more reliable measurements.
Fabry-Perot interferometer. Here, strain (tensile force) applied to the fiber stretches it. Usually, such sensors have an optic fiber with a small gap, and the width of the gap is changed under a tension applied to the fiber. So, the wavelength of the light reflected from this gap is shifted that can be precisely measured.
Scattered light sensors (Brillouin scattering). Another physical principle utilized in the strain sensors is the light scattering. Here, the strain measurement is based on a variation of scattered light produced by an incident light launched into the fiber. The strain applied to the silica fiber changes structure of the material so changes the back reflection caused by the scattering.
Fiber-optic polarimetric sensors. These sensors utilize the photoelastic effect, the phenomenon of polarization conversion of the light running in optic fiber under stress applied to the fiber. In this case, some external mechanical forces applied to the fiber can induce a birefringence in the fiber core so converting input polarization. A polarization analyzer sequentially installed after the sensor transforms the polarization deviation into amplitude modulation of the light running in the fiber.
Reflective diaphragm sensors. Such sensor that is, in particular, described in U.S. Pat. No. 6,838,660 issued Jan. 4, 2005 to Duncan, contains a reflective diaphragm installed in proximity with an end of fiber-optical line. The light coming from the line is reflected backward by a flexible diaphragm, which is axially moved by some physical phenomenon, such as gas pressure, acoustic wave, etc. Because the distance between the fiber end and the diaphragm has not to exceed 20-30 microns, such sensor will be highly affected by ambient conditions, such as temperature variation, vibration, etc. So, it is useless for measurement of stationary parameters (varying with low frequency), but can be utilized in microphones, hydrophones, etc.

The review of the existed fiber-optic strain sensors, its principles and designs reveals that the sensors mentioned above have some disadvantages, such as high cost and complexity of measuring equipment. In some cases, the data collecting systems utilizing these sensors have problems with the measurement instability, temperature and polarization sensitivity (especially, interferometer-based sensors). Moreover, measuring system implementing fiber-optic strain sensors based on Bragg grating technology requires complicated multi-line single-mode light source that has to provide large number of spectral lines, or multi-line wavelength scanning light source. Also, all of mentioned above sensors requires a reference fiber placed in proximity with the measuring one to compensate sensor deviation caused by ambient conditions. Therefore, for mass applications, such as pipeline pressure and temperature monitoring, it is necessary to develop a low cost, simple design, stable in different ambient conditions and reliable fiber-optic gage based on alternative approach.

There is another principle that a fiber-optic gage could be based on. It is the light attenuation caused by small-radius bending of an optic fiber. This phenomenon had been discovered when the first optic fibers were invented and tested.

At the first time a general idea of optic fiber bending utilization for a mechanical phenomena measurement had been introduced in U.S. Pat. No. 4,358,678 issued Nov. 9, 1982 to Lawrence. Author of the mentioned patent proposed curvature changing of an optic fiber loop that changes amplitude of a light running in the fiber. Here, the author utilized phenomenon of internal reflection of the light that occurs in step-index multimode optic fibers, and all devices and ideas of this patent are dedicated to this kind of fiber. In this case, when such multimode fiber—the sensing element of the proposed devices—is bent, the number of modes of the light running in the fiber declines, so total transparency of the fiber declines too. The patents issued latter, such as U.S. Pat. No. 4,436,995 issued Mar. 13, 1984 to Whitten, U.S. Pat. No. 4,734,577 issued Mar. 29, 1988 to Szuchy and U.S. Pat. No. 5,196,694 issued Mar. 23, 1993 to Berthold, also deal with multimode optic fiber (400, 600 and 1000-micrometer core) that were proposed as a sensing one. Moreover, a data collecting system utilizing these sensors was not specified. Research of the possibility of optic fiber utilization for physical phenomena sensing reveals that multimode fiber are not suitable for such measurements, because they do not provide stable and repeatable reading. This disadvantage is caused by the multimode mechanism of light propagation in step-index multimode fibers, where the number of modes can reach up to a few hundred ones and each mode has its individual losses.

More advanced kind of multimode fiber, the graded-index one, which utilizes different mechanism of light propagation can, also, transmit a single-mode optic signal (“Additional Features of Gradient Multi-Mode Optical Fibers”, Technology News, http://www.Imgr.net/Technology-News01.htm). The experiments conducted by the author of the present invention shows that such fibers are completely insensitive to bending (for single-mode light signal).

Also, utilization of multi-mode fiber-optic sensors requires multimode fiber-optical lines collecting data from the sensors that can not be longer than a few hundred meters that drastically restricts applicability of these sensors for remote monitoring. Because of the problems mentioned above, the fiber-optic sensors based on this effect can not be successfully utilized for mass application in monitoring systems.

The similar phenomenon of light attenuation in bent optic fiber was detected in single-mode optic fibers despite the fundamental difference of the mechanisms of light propagation in these fibers. In these fibers, the single-mode light propagation is based on light diffraction. For single-mode optic fibers this effect is more stable and repeatable and they are more sensitive to bending. Moreover, utilization of single-mode fibers in such sensors allows creating multi-sensor all-optical data collecting network for remote monitoring, which is based on novel telecommunication technology and utilizes conventional single-mode fiber-optical lines. In this case, the length of the optical line can reach tens of kilometers; and the newest all-optical switching technology can be implemented in such network.

As experiments conducted by the author of the present invention show: if bending radius of a single-mode optic fiber becomes smaller than about 9 mm, the intensity of a single-mode light running in the fiber gradually declines. When the bending radius becomes smaller than two millimeters the light transmission is completely terminated. This effect appears in a conventional 9/125-micrometer single-mode optical fiber. Also, experiments conduced by the author of the present invention reveal light attenuation dependency on bending radius and arc angle of fiber bending. These experiments show that a single-mode light attenuation introduced by the bending of a single-mode fiber can be described by formula:
Pₒᵤₜ/Pᵢₙ=[f(r)]^{φ} (1),
where f(r)—the function of light attenuation from radius of bending, φ—arc angle of bending [radians], Pᵢₙ—input power of the light and Pₒᵤₜ—output power. Because in telecommunication industry signal amplification and attenuation is measured in decibels (A [dB]=10 log Pₒᵤₜ/Pᵢₙ), the formula above can be transformed into the logarithmic one. Thus, this formula (for fixed-radius arc) looks as:
A [dB]=F(r)φ (2),
where F(r)=log f(r) and φ—arc angle of bending [rad].

For variable radius this formula looks as:
δA [dB]=F(r)δφ (3).

Here, F(r) can be defined as the specific attenuation [dB/rad].

Because freely bent silica fiber has complicated shape, not a circular one, F(r) varies along the fiber, and this formula looks as:
A [dB]=Σ(δAᵢ)=ΣF(rᵢ)δφ (4).

The function of specific attenuation F(r) (in dB/rad) from radius of bending (r) taken at 1310-nm wavelength is shown on FIG. 1. It is a non-linear one that significantly increases for lesser radius and asymptotically rises at 2.5-mm radius. This dependence in the first approximation can be described by the formula (for 9/125 single mode fiber, 1310-nm wavelength and radius range from 3.5 mm to 8 mm):
F(r)=(4.4/r)^{4.6} (5),
where F(r) is taken in dB/rad, and r—in mm.

Therefore, there is a range of the bending radius (approximately, from 3.5 to 6 mm) that can be utilized for the measurements.

The total attenuation A linearly depends on the angle of bending. It means that attenuation (measured in dB) is twice higher for 360-deegree loop than for 180-degree arc. For example, attenuation measured for 9.6-mm bending diameter and 180-degree arc is 2.2 dB at 1310-nm wavelength, and for 360-degree loop of the same diameter is 4.4 dB. When the fiber is coiled as a multi-turn winding, the attenuation (in dB) increases proportionally to the number of turns. Thus, the formula for total light attenuation (1310-nm wavelength) induced in the multi-turn winding can be described by the formula:
A [dB]=2πN(4.4/r)^{4.6} (6),
where radius r is taken in mm, and N—the number of turns.

Thus, it becomes possible to use higher radii of the bending, such as 6-7 mm. In this case, because the range of working displacement becomes larger, whereas some undesired mechanical movements (caused by temperature, vibration, etc.) still the same, the gage is much less affected by ambient conditions.

There is another problem significantly affecting characteristics of the fiber-optic sensors described in the mentioned patents. All of them deal with “micro-bending” of optic fiber. Here, an optic fiber is sharply bent with small bending radius to achieve the maximal response. In such sensors the sensing length of the fiber is small; the shape of the bent part is formed by applied force and natural flexure of the fiber, unlike the conventional resistance strain gages where the sensing resistor bridge is firmly fastened on special mechanical element and experiences the same shape transformation as this element, which characteristics are precisely calculated. Therefore, the shape of the fiber loop formed by such way is unstable and highly depends on ambient conditions, such as temperature (changing flexure of the fiber), etc. Moreover, in such sensors the maximal response is produced by intermediate parts of the bent fiber—the parts between end fibers and the loop, which are less controllable.

As the result, despite of variety of patented fiber-optic micro-bending sensors, most of them have not found application in practice (other than for alarm mode or tactile sensing) due to problems associated with erratic response, tolerances of the deformers and mechanical fatiguing of the fiber that especially appears at high temperature condition because of viscoelastic deformation of the glass (G. Scott Glaesemann, et al “Analysis of optical fiber failures under bending and high power”, Reliability of Optical Fiber Components, Devices, Systems, and Networks II, Vol. 5465; pp. 1-10; 2004).

To solve this problem, the method of the fiber bending has to be modify to provide the adequant response; so, the attenuation induced in the fiber by the measured paraneter must follow the parameter, be stable and repeatable.

To achieve it, the fiber loop shape transformation has to be predictable and highly controllable. The research conducted by the author of the present invention shows that there are a couple of principles of fiber bending that was further utilized in the present invention, which can allow creating the fiber-optic sensors with stable parameters. One of these principles is to avoid sharp bending. Such bending produces high attenuation, but it is unstable, affected by small unwanted displacements and can cause the fiber failure. Also, to avoid unwanted bending of intermediate parts of the optic fiber, the fiber ends has to be tangential to the fiber loop. For example, for circular (or elliptical) multi-turn winding, the end fibers have to be tangential to the winding. In the case of bending around a fixed radius shaft, the end fibers, also, has to be tangential to the shaft circle. Those principles are described by the drawings on FIG. 2.

FIG. 2 A depicts the bending method that, in particular, was utilized in U.S. Pat. No. 5,818,982 issued Oct. 6, 1998 to Voss. Here, freely bent fiber has a complicated Ω shape with sharp bent parts. These parts provides high attenuation, but they are unstable, affected by small unwanted displacements and can cause the fiber failure.

FIG. 2 B depicts another bending method (utilized in the present invention) that allows avoiding such sharp bending. Here, the end fibers are organized in such a way that the sensing fiber appears as a pure geometric curve (parabola), which variables depend on the measured parameter.

FIG. 2 C depicts the object of the present invention—the transformation of multi-turn winding from circular into elliptical one. Here, such transformation is performed by radial stretching of the winding. In this case, the curvature of the fiber is changed according to mathematics formulas; it is predictable and stable. Also, the end fibers are tangentially positioned to the fiber curve. The light attenuation produced by such bending can be calculated by formulas (4) and (5).

FIG. 2 C depicts another object of the present invention—the bending around a fixed-radius shift. In this case, the fiber can be bent as an arc with variable arc angle. Here, also, the end fibers are tangential to the shaft circle.

Because the light attenuation (in dB) induced by this kind of bending is in proportion with the angle of bending, gages utilizing such bending can provide linear-logarithmic reading (see formula (2)). Such linear response can be convenient in many cases. For example, for a pressure gages based on such bending, the measured pressure can be determined by a simple formula:
P=cA (6),
where P [Pa]—measured pressure, A [dB]—light attenuation induced in the sensing fiber of the gage by this pressure, and c—a constant that is individual for each particular design of the gage.

This kind of the bending can be effectively utilized in gages, whose mechanical transducers transform the measured parameter into rotational movement of the shaft.

The experiments conducted by the author of the present invention, also, reveal that the light attenuation introduced by the bending very depends on the light wavelength and appears higher for longer wavelength.

The idea of utilization of a dual-wavelength light source in sensors based on optic fiber bending was introduced in U.S. Pat. No. 4,727,254 issued Feb. 28, 1988 to Wlodarczyk, where the author proposed the second wavelength (shifted on 10% against the first one) as a not-disturbed reference one. Based on his experiments, he decided that the signal of some second wavelength is not affected by the fiber bending; therefore this signal is not disturbed by bending and could be used as a reference one.

The experiments with 9/125 single-mode optic fiber, which were conducted by the author of the present invention, reveal (unlike the experiments conducted be the author of U.S. Pat. No. 4,727,254) that the signals of both wavelengths are affected by the bending; there is not such wavelength that could be used as a reference one. Theoretically, for the signals of standard telecommunication wavelength (1310 and 1550 nm, which are shifted on 18% against each other), there is a very narrow range (about 1-1.5 dB), in which 1550-nm signal starts being disturbed by the bending, whereas 1310-nm one still relatively stable (in fact, it declines on 0.2 dB); but when the bending radius continue decline, the 1310-nm signal start being affected immediately. Also, theoretically, it seems possible to use two highly-spaced wavelength, such as 1310 and 630-nm ones; but the single-mode fiber becomes multimode one for the second wavelength. The signal of such wavelength has unstable characteristics, can not be properly transmitted via a conventional single-mode line; and, as result, it can not be used as a reference one.

It seems that the idea and the method proposed by the author of U.S. Pat. No. 4,727,254 can not properly work in the devices and data collecting systems based on bending of single-mode optic fiber.

Nonetheless, multi-wavelength single-mode optical signals can be successfully utilized to receive additional information about the fiber bending that represents the measured phenomenon. In this case, the signal ratios obtained for the signals having different wavelength are used together with the signal attenuations measured for each wavelength individually. This approach allows significantly increasing the measurement accuracy. For dual light source (1310/1550-nm), the ratio of the signal attenuations can be described by formula:
Rr=A₁/A₂=ΣF₁(rᵢ)δφ/ΣF₂(rᵢ)δφ (7),
where F₁(r) and F₂(r)—function of light attenuation for 1310-nm and 1550-nm wavelengths. In many cases of single-mode fiber bending the signal attenuation A and the ratio R are depend on the both arguments, the bending radius r and bending arc angle φ, but, in the case of the bending around fixed-radius shaft, the ratio Rr=F₁(r)/F₂(r)=F(r)=const, and it is not depend on φ—the arc angle of bending.

The idea of utilization of multi-turn fiber-optic coil was disclosed in U.S. Pat. No. 5,164,605 issued Nov. 17, 1992 to Kidwell, where the author used axial stretching of a spring-shaped coil to measure a mechanical displacement. According to the tests conducted by the author of U.S. Pat. No. 5,164,605, such sensor design provides up to 1.6-dB light attenuation range at 100-inch displacement.

Such range is, obviously, not enough for reliable measurements, because any deviation of parameters of light source and optical line, which can achieve about 0.2-0.3 dB drastically diminish accuracy of such measurements. Also, the experiment conducted by the author of the present invention shows that the proposed mechanical disturbance of the coil—an axial stretch, which was utilized in the U.S. Pat. No. 5,164,605 little affects amplitude of single-mode light signal running in the fiber.

Nonetheless, utilization of the bending device—one of the objects of the present invention—that applies proper mechanical disturbance on a multi-turn coil of single-mode optic fiber allows significantly extending the light attenuation range so increasing reliability and stability of the measurements.

Therefore, conversion of a measured physical phenomenon, for example, gas pressure into the proper bending of 9/125 single-mode optic fiber allows reliably measuring this phenomenon.

The fiber-optic gages of the present invention utilize this effect, and when the gage is affected by a measured physical phenomenon, such as pressure, temperature and force, the sensing single-mode optic fiber coiled into multi-turn winding realizes corresponding transformation from circular to elliptical one. In another design proposed in the present invention, the sensing fiber is controllably bent with fixed bending radius, wherein the arc angle of this bending is in proportion with the measured parameter. These methods of bending produce measurable, predictable and repeatable light attenuation variation. Also, the fiber-optic gages of the present invention can work in on-off alarm sensors.

Another object of this invention, a multi-channel single-mode data collecting system gathering measurements performed by the fiber-optic gages, is based on novel schematic solutions developed for single-mode fiber-optical telecommunication lines including all-optical time-division multiplexing units, such as Acousto-Optical Switch for Fiber-Optic Lines described in U.S. Pat. No. 6,539,132 issued Mar. 25, 2003 to G. Ivtsenkov et al, or another object of the present invention—a single-mode fiber-optic switch—which also based on the effect of light attenuation introduced by bent single-mode fiber. Here, this effect is utilized in on-off fiber-optical switching units. For multi-line switching, these units are connected to fiber-optic splitter/combiner. Such combination allows switching single-mode fiber-optical lines in time sequences. The data collecting system of the present invention allows utilizing regular single-mode fiber-optical lines, similar to ones used for telecommunication. It can be “dark fibers” or any fiber-optical telecommunication lines modified for transmission of analog signal.

This data collecting system can perform programmable monitoring of remote objects gathering information from large number of the gages. Additional utilization of multi-wavelength light source in this data collecting system allows increasing the data reading reliability and accuracy.

### OBJECT OF THE INVENTION

It is an object of the present invention to provide a low cost, simplified and insensitive to ambient conditions fiber-optic gage for measuring physical phenomena, such as pressure, temperature and force, which utilizes effect of light attenuation in a single-mode optic fiber, induced by the specific bending of the fiber. Another object of the present invention is to provide a multi-channel fiber-optical data collecting system simultaneously or in time sequences gathering information from a number of said gages.

### SUMMARY OF THE INVENTION

The present invention alleviates the disadvantages of the prior art by utilization of the phenomenon of single-mode light signal attenuation caused by the specific bending of single-mode optic fiber, mechanical transducers converting measured parameters into specific bending of the optic fiber, and associated single-mode multi-channel data collecting system implementing the novel telecommunication technology for single-mode fiber-optical lines.

Particular features of this fiber-optic gage according to the present invention are a sensitive element—a length of 9/125 single-mode optic fiber—converting the fiber bending into a variation of light attenuation of single- or multi-wavelength single-mode optical signal passing the fiber, and a mechanical transducer transforming the measured parameter into specific bending of the fiber.

The method of the present invention comprises the steps of providing a single- or multi-wavelength single-mode light signal, delivering the light signal to the gage via single-mode fiber-optical line, transformation of a measured parameter into specific bending of the optic fiber causing modulation of the light intensity, transmitting the modulated light signal to light detectors via single-mode fiber-optical line, and processing the signal by electric-optical unit to measure the attenuation variation that is indicative of parameter. The measured parameter is, thus, determined from the sensed intensity variation.

Also, the present invention additionally comprises the time-division multiplexing/demultiplexing unit, such as fiber-optic switch that time-sequentially collects signal from large number of the gages.

There can be a few possible designs of such gage that utilize the fiber bending proposed in the present invention to provide the highest effect. The gage and data collecting system may be used for monitoring gas and liquid pressure, temperature, force, structural element movement, or any other phenomena that can be converted into the fiber bending. For sensing a structural movement, base of the gage is attached to the area of interest, causing the fiber to experience the bending. For pressure, temperature and force sensing, the gage is equipped with mechanical transducer converting the measured phenomenon into specific bending of the single-mode optic fiber.

Because of relatively high linear movement of the fiber, which is utilized in the bending devices of the present invention, possible influence of ambient conditions, such as temperature, vibration, etc. is negligible. This approach allow eliminating the second optic fiber—a reference one—that is essential for the gages based on mentioned above principles to compensate ambient condition variations. Thus, this invention allows drastically simplifying design of the gage and associated data collecting system, therefore, increasing reliability and minimizing the cost of the system.

The single-mode multi-channel data collecting system described in this invention can measure a number of parameters simultaneously or in time sequences. The system is completely fiber-optic one that does not contain any spatial elements, such as lenses, mirrors, plates; it is the solid, polarization insensitive and contains the only sensitive elements—the measuring fibers.

The method and apparatus proposed in this invention reflects industrial requirements for all-optical data acquisition system that will allow utilizing this system in large variety of applications. Particularly, the system proposed in the present invention may be implemented in fire and explosive hazardous places, such as oil refineries, gas pipelines, munitions deports and others where electrical devices can not be used, and, also, in high electromagnetic interference environment.

### DETAILED DESCRIPTION OF THE PREFERRED EMBODIMENTS OF THE INVENTION

The scheme of the invention—multi-channel all-optical data collecting system gathering information from a number of fiber-optic gages—is depicted in FIG. 3. An electro-optical module 100 comprises a transmitting unit 101, receiving unit 110 and processing unit 113. The transmitting unit 101 of the electro-optical module 100 contains a single-mode fiber-optic source of light, such as a 1310-nm (or 1550 nm) laser diode developed for telecommunication lines. The light source of the unit 101 is optically coupled to an input single-mode fiber-optical line 105, and the light entering the fiber-optical line 105 propagates along that line until it reaches the sensing module 200. In that module, the light passes through a single-mode splitter 201 with number of outputs equal to the number of gages 203. Each output of splitter 201 is optically coupled to delivering single-mode fiber-optical lines 202 transmitting the light to each individual gage. Therefore, the light further propagates along each delivering fiber-optical line 202 until it reaches the gages 203. Each gage 203 contains a single-mode optic fiber—the measuring optic fiber 205—and a mechanical transducer 212 converting measured parameter into specific bending of the measuring fiber 205. The outputs of the gages 203 are optically coupled to output single-mode fiber-optical lines 106 combined in multi-channel fiber-optical cable. Thus, the light passed through the sensing module 200 returns to the electro-optical module 100 via the fibers 106 optically coupled to photodetectors of the receiving unit 110, where number of the photodetectors is equal to number of the gages 203, and each photodetector is exclusively dedicated to each particular gage 203. The outputs of these photodetectors are then fed to the processing unit 113.

Therefore, the single-mode optical signal sequentially passes the input single-mode fiber-optical line 105, single-mode splitter 201, one of the delivering single-mode fiber-optical line 202, the single-mode measuring fiber 205, one of the output single-mode fiber-optical lines 106, and is finally transformed into electrical signal by photodetectors of the unit 110. Here, the splitter 201 splits the optical signal to feed a number of gages 203. The light passed all mentioned above elements of the optical contour may randomly change its polarization without affecting the data because of polarization insensitivity of the gages 203 and photodetectors of the unit 110. In the case of a single-wavelength light source, the initial optic losses of the fiber-optical lines 105, 106, 202 and splitter 201 are measured and further subtracted from the total losses to obtain the light attenuation induced by the gages 203. The gages 203 are individually calibrated, and the calibration table is loaded in the processing unit 113, which calculates value of the parameter affecting each gage 203 by processing the data received from the measuring fibers. Because of relative high linear movement of the measuring fiber that is necessary for the bending, possible influence of ambient conditions is negligible. This approach allows eliminating ambient effects, such as temperature instability, vibration, etc.

### OTHER EMBODIMENTS OF THE INVENTION

Another embodiment of multi-channel all-optical data collecting system of the present invention incorporates a number of single-mode fiber-optic light sources having different wavelengths. The diagram of this embodiment utilizing two light sources having different wavelengths is depicted in FIG. 4. This embodiment additionally comprises a fiber-optic light source 121 emitting 1310-nm single-mode radiation, the similar fiber-optic light source 122 emitting 1550-nm single-mode radiation and dual-wavelength fiber-optic combiner 123, which combines two optic signals in an input single fiber-optic line 105. The dual-wavelength optic signal passes sensing module 200 containing gages 203 and returns backward to the receiving unit 110 of the electro-optical module 100 via the output fiber-optic lines 106. In this embodiment, the electro-optical module 100 comprises wavelength-demultiplexing units 125 separating these two wavelengths; and the receiver 110 contains pairs of photodetectors 130 and 131 transforming 1310 and 1550-nm optical signals into electric ones, where the number of the units 125 is equal to the number of the gages 203. The outputs of these photodetectors are then fed to the processing unit 113. The gages 203 are individually calibrated at 1310 and 1550-nm wavelengths and the calibration tables are loaded in the processing unit 113. In this case, each gage 203 is calibrated to obtain three calibration tables P=f₁(A₁), P=f₂(A₂) and P=f₃(R), where A₁ and A₂—the signal attenuations measured for 1310 and 1550-nm wavelength respectively, and R=A₁/A₂—ratio of the attenuations. Thus, when the gage is affected by pressure P (or another parameter), three independent variables A₁, A₂ and R can be directly measured and processed that allows determining this parameter P. Because three separate dependences are involved here, the accuracy and repeatability of the parameter reading is much higher in comparison with single-wavelength light source, where only one dependency is available (for example, P=f(A₁) for 1310-nm wavelength).

Scheme of the Invention Utilizing a Multi-Channel Fiber-Optic Switch

Another embodiment of this invention—a multi-channel single-mode fiber-optic gage data collecting system—utilizes a multi-channel fiber-optic switch. The scheme of this embodiment (for single-wavelength light source) that allows gathering information from large number of fiber-optic gages is depicted in FIG. 5.

FIG. 5 shows part of the diagram different from one shown on FIG. 3. This embodiment comprises a multi-channel fiber-optic switch 107, which provides for large number of the fiber-optic gages 203 sequential access to the receiving unit 110 containing a single photodetector 111. In this embodiment the output single-mode fiber-optical lines 106 are optically coupled to inputs of N×1 photonic switch 107 having single output and number of inputs equal to the number of fiber-optical lines 106. The switch 107 sequentially connects each output of gages 203 to input of a single fiber-optical line 108. The output of the line 108 is optically coupled to a single photodetector 111 that converts the optic signal into electrical one. The output of this photodetector is then fed to processing unit 113.

This embodiment allows transmitting data developed by sensing module 200 to electrical-optical module 100 via single fiber-optical line 108. The switch may be incorporated in sensing module 200 or placed in proximity to the module. In the case of hazardous place monitoring, the switch containing an electronic controlling unit may be placed in a safe place near the monitored site.

Here, the switch sequentially connects the outputs of gages according to a switching schedule written in switch software that may reflect any monitoring requirements. The photonic switch can be based on the single-mode fiber bending technology (the object of the present invention), MEMS technology, or Acoustic Optical technology (U.S. Pat. No. 6,539,132 issued Mar. 25, 2003 to G. Ivtsenkov at al.).

Possible utilization of these switches in any particular network depends on the network requirements, such as number of gages and switching time. For example, the first option—the switch of the present invention—can serve up to ten gages in time sequences with the switching time of hundreds milliseconds. The second option—two-dimensional MEMS switch—can serve up to 32 gages with switching time of tens milliseconds, and the third option—the Acoustic Optical switch can serve up to 1000 gages with the switching time of microseconds.

Also, this embodiment of the invention can additionally comprise the multi-wavelength light source, the fiber-optic combiner, the wavelength-demultiplexing unit and the photodetectors according to the diagram shown on FIG. 4.

Scheme of Gage Assembly

Gage 203 can be configured as depicted in FIG. 6. In this embodiment, gage 203 incorporates specially positioned measuring fiber 205, input and output fiber-optic connectors 209, 210, and mechanical transducer 212 converting measuring parameter, for example—gas pressure, into mechanical movement of an element of the transducer. The mechanical transducer 212 comprises a mechanical transformer 208 converting the measured phenomenon, for example, gas pressure, into mechanical movement of its element and a bending device 211 that further converts the mechanical motion of the transducer's element into specific bending of the measuring fiber 205. The output optical signals can be transmitted to electro-optical module 100 via single-mode fiber-optical lines 106 (see FIG. 3, FIG. 4 and FIG. 5). All fiber-optical lines of this invention are single-mode conventional ones because gages 203 and photodetectors 111 of module 100 are insensitive to light polarization.

Design of the mechanical transformers 208 can vary and very depends on measured parameter. The transformer 208, the one of the main parts of transducer 212, is a mechanical element that converts measured parameter into linear or rotational motion. Basically, these elements are very similar to ones that were utilized in conventional gages for decades, such as hollow cylinders extending under applied pressure, hollow spirals, bimetallic plates, etc. All of them can be used in the gages to transform the specific parameter into linear or rotational motion of transducer's element.

Another main element—the object of this invention—is the bending devices 211 providing the highest response to this motion. There are two principles of the fiber bending utilized in this invention, which provide high-sensitive, reliable and repeatable conversion of the bending into single-mode light signal attenuation: controllable stretching of multi-loop fiber-optic coil and controllable winding the fiber around a fixed-radius shaft. In the first case, initially circular winding is transformed into elliptical one, therefore, changing the bending radius. This approach is the preferable one for gages having the transducers, which convert the measured parameter into a linear motion.

In the second case, the fiber is wound around a fixed-radius shaft. Thus, the bending radius is fixed, and only bending angle is changed. This approach is the preferable one for gages having the transducers, which convert the measured parameter into a rotational motion.

Gage Embodiment for Sensing Gas and Liquid Pressure

This is an example of the gage embodiment that allows sensing gas and liquid pressure. To sense gas and liquid pressure, the invention can be embodied as depicted in FIG. 7. In this embodiment, the measured pressure is transformed into bending of measuring fiber 205 by extending device—a cylindrical chamber 240 installed in a box 241, wherein chamber 240 having flexible corrugated cylindrical walls is internally exposed to measured pressure, and the box 241 has openings 243 to allow outside pressure externally affecting the chamber 240. Because of this, measured pressure extends the chamber 240. The bottom of the chamber 240 is connected to shaft 246 translating the chamber 240 extension to a bending device 247.

The bending device 247 is based on shape transformation of multi-turn coil of optic fiber. The bending device contains frame 245 and two low-radius cylindrical rods (holders) 248 and 249, around which the fiber 205 is freely coiled in circular winding 252. The fiber 205 optically coupled to fiber-optic connectors 254 and 255. The rod 248 is mounted on stationary part of the frame 250 that is firmly fixed to the box 241. The rod 249 is mounted on movable part of the frame 251 and can slide in slot 253. Therefore, the distance between rods 248 and 249 can be extended that transforms the shape of the winding 252. A spring 256 provides additional force that pulls the rods together preventing them from occasional movement.

When pressure P is applied, the chamber 240 axially elongates pushing the movable part of the frame 251 with the rod 249. Thus, the coil 252 changes its shape from circular to elliptical one, therefore, the radius of fiber bending diminishes in the parts of ellipse, where the coil 252 touch the rods 248 and 249. Therefore, fiber 205 experiences the bending shape transformation that changes attenuation of light passing the fiber. Because the total attenuation (in decibels) of the light signal is the sum of attenuations caused by single bending, the multi-turn elliptical winding having 2N low-radius bending (where N is the number of turns) allows proportionally increasing the gage sensitivity.

This gage was prototyped and tested. The test reveals reliable and repeatable dependence the light attenuation on applied pressure, where the light attenuation range achieves 23 dB at 1310 nm and 45 dB at 1550 nm without any permanent deformation of the fiber. Changing flexibility of the extending device and the spring 256 can adopt the gage for any measuring pressure.

In this embodiment, any kinds of extending devices, such as hollow cylinder, hollow spiral or flexible plastic bags expanded under applied pressure can be utilized. In the case of the plastic bag utilization, the gage can be used as a low-cost on-off alarm sensor.

The embodiment of the bending device 247 can be modified to use flexibility of special element instead of utilization of the natural flexure of the optic fiber 205. The part of the bending device 247 utilizing a spring as a flexible element is depicted in FIG. 7a. In this case, the bending device 247 additionally comprises a cylindrical spring mandrel 257 mounted on the rods 248 and 249 in such a way that the mandrel 257 has a circular shape when the gage is not affected by pressure. The winding 252 is reeled and fixed on cylindrical surface of the mandrel 257. Therefore, when the rod 249 moves, the mandrel 257 changes its shape from circular to elliptical one, and the winding 252 experiences the same shape transformation. Here, the spring 256 pulling the rods 248 and 249 together (FIG. 7) can be eliminated.

This approach allows simplifying the technological procedure of the fiber coiling, also providing more repeatable and stable gage characteristics.

Another embodiment of the bending device 247 of the gage is depicted in FIG. 8. In this embodiment, the bending device 247 is based on winding of the measuring fiber 205 around a fixed-radius shaft 256. Here, the optic fiber, which is freely winded in a large-radius spiral, is fixed on the shaft 256 at single spot by adhesive 257. When the shaft 256 turns, the fiber 205 is applied on the shaft. In this case, the fiber 205 is bent around the shaft 256 as an arc, wherein the angle of the arc is equal to turning angle of the shaft 256. Two specially shaped bars 258 and 259 direct the fiber 205, therefore, organizing the proper bending of the fiber. Here, the bar 258 is firmly fixed on a stationary frame 265, and the bar 259 is mounted on rotating plate 266, wherein the rotating plate 266 turns together with the shaft 256. Such design prevents sharp bending of the optic fiber 205 and organizes proper winding of the fiber. Thus, attenuation of the light signals increases logarithmic-proportionally (in dB) with the turning angle of the shaft 256. The shaft 256 is mechanically connected to a mechanism 267 that transforms the measured parameter into rotational movement. For example, it can be a hollow spiral 261, turning the shaft under a pressure applied to internal channel of the spiral. In the case of temperature measurement, the spiral 261 is the bimetallic one converting the temperature variation into rotational movement of the shaft 256. The bending device on FIG. 8 is shown in the position when the shaft 256 is turned on 90 degrees clockwise against the initial position. The fiber 205 is optically coupled to fiber-optic connectors 263 and 264.

Gage Embodiment for Sensing Temperature

This is another example of the gage embodiment that allows sensing temperature. To sense temperature, the invention can be embodied as depicted in FIG. 9. In this embodiment, the measured parameter—temperature—is converted into bending of optic fiber 205 by the bending device 247, which is similar to one depicted in FIG. 7. It contains the frame 245 having the stationary part 250 and the movable one 251, two low-radius cylindrical rods (holders) 248 and 249 around which the fiber 205 is freely coiled in the circular winding 252, and the spring 256. Here, an actuator moving the bending device is a bimetallic plate 271, one end of which is mounted on a wall of box 272 and another one is in mechanical contact with movable part of the frame 251. The stationary part of the frame 250 is firmly mounted on another wall of the box 272. When measured temperature rises, it bends the bimetallic plate, therefore, pushing the movable part of the frame 251 and, thus, changing the distance between rods 248 and 249. It changes the diameter of bending of the fiber 205 causing light attenuation variation that is indicative of the parameter.

The fiber 205 is optically coupled to fiber-optic connectors 274 and 275.

In this embodiment, the bending device 247 comprising the cylindrical spring 257 (as depicted in FIG. 7a) can be also utilized.

To measure high temperature (up to a few hundred degrees) the 9/125 single-mode fiber 205 has to contain the silica core and clouding only (without any plastic jacketing), and the gage has to be made from temperature-resistant materials.

Bidirectional Fiber-Optic On-Off Switch Embodiment

The switch of the embodiments described below, another object of the present invention, is based on the same principles that are utilized in the fiber-optic gages of the present invention. In particular, this switch can be utilized in the data collecting system of the present invention.

The pressure gage depicted in FIG. 7 can, also, works as on-off optical switch. In this case, the transducer 212 (FIG. 6) shifts the rod 249 (FIG. 7) of the bending device 211 (FIG. 6) in the position when the winding 252 (FIG. 7) introduces high attenuation of the light signal running in the winding so completely terminating the signal transmission. The transducer 212 may utilize any mechanism, which provides necessary linear movement, such as electromagnetic solenoid, step motor, air cylinder, etc.

The bending devices of the present invention can be modified to switch optical signals in any fiber-optical network, such as telecommunication or data collecting one. Because the switch works in on-off mode only that, unlike the fiber-optic gages of this invention, does not require precise attenuation/bending characteristics, a step-index multi-mode fiber can be utilized here. Such multi-mode switch can be utilized in multi-mode fiber-optical network.

Bidirectional 1×2/2×1 Fiber-Optic Switch Embodiment

Another embodiment of the invention is shown on FIG. 10 and FIG. 10a. Here, the light attenuation induced by bent fiber is utilized in a bidirectional fiber-optic switch sequentially connecting single input with two outputs that provides 1×2/2×1 configuration.

The switch comprises a fiber-optic splitter/combiner 307 and on-off module 300 (FIG. 10a). The module 300 utilizes the same principle that is used in pressure gage depicted in FIG. 7—the light attenuation induced by stretched multi-turn fiber-optical coil.

In this embodiment (FIG. 10), the module 300 contains two separate multi-turn fiber-optical coils 301 and 302, which ends are connected to fiber-optic connectors 303, 304, 305 and 306. The coils 301 and 302 are wound around rods (holders) 309, 310 and 311, where the rods 309 and 311 are the stationary ones and the rod 310 can move against the frame 312. The rods 309 and 310 are firmly mounted on stationary frame 312. The rod 310 is mounted on movable frame 313 that can slide in the slot 314 machined in the frame 312. The movable frame 313 is in mechanical connection with actuator 315. The coil of optic fiber 301 has initially a circular shape and is freely wound around rods 309 and 310. The coil 302 is initially wound around rods 310 and 311 as a stretched ellipse. In the position shown on FIG. 10, the coil 302 introduces high attenuation of the light completely terminating light transmission, and the coil 301 having circular shape does not induce any attenuation. Therefore, the light signal passes the fiber-optic circuit between connectors 303 and 304 without attenuation, and the circuit between the connectors 305 and 306 is closed.

When the actuator 315 pushes the rod 310, the coils 301 and 302 shift the shape—the coil 301 becomes elliptical and the coil 302—circular. Thus, the fiber-optic circuit (inside the module 300) between connectors 303 and 304 becomes closed, whereas the circuit between connector 305 and 306—opened. The switch contains the splitter/combiner 307 (FIG. 10a) whose outputs are in optical connection with connectors 303 and 305 of the module 300. Therefore, the on-off module 300 sequentially opens and closes each output of the splitter/combiner 307 providing time-sequential switching of the light signal between outputs 1 and 2 (FIG. 10a).

Because the splitter/combiner 307 and optical circuits of the module 300 are bidirectional ones, the switch can work in both directions: time-sequentially connecting the single input to two outputs (1×2-configuration) or connecting any of two inputs with the single output (2×1-configuration).

The switch can be cascaded and works in N×N configuration. The number of switched channel is restricted by attenuation introduced by the splitter/combiner, whereas the attenuation introduced by opened optical circuit (circular-shaped fiber-optical coil) of the module 300 does not exceed 0.2-0.3 dB. Therefore, the total attenuation of the opened channel (“insertion loss”) is about 3.5 dB for two outputs, and increases up to 10 dB for ten outputs.

Because the switch works in on-off mode only that, unlike the fiber-optic gages of this invention, does not require precise attenuation/bending characteristics, a step-index multi-mode fiber can be utilized here. Such multi-mode switch can be utilized in multi-mode fiber-optical lines.

The 1×2 single-mode fiber-optic switch of this embodiment was prototyped and tested. The module 300 of the prototype contains two 9/125 single-mode optic fiber coils of 40-mm diameter having three turns. The operational travel of the rod 310 is 16 mm. The test reveals the total “insertion loss” of 3.5 dB (opened channel) and 55 dB “crosstalk” (closed channel) at 1550 nm. The switch, also, was tested for periodical switching with the switching time of 0.5 sec. The tests reveal that the switch provides reliable and stable characteristics without permanent deformation of the optical fiber (coils 301 and 302). The actuator 315 pushing the rod 310 may be based on any mechanism, which provides necessary linear movement, such as electromagnetic solenoid, step motor, air cylinder, etc. In the case of the air cylinder (shown on FIG. 10), compressed gas (air, nitrogen, helium, etc.) feeds the cylinder so pushing the rod 310. This embodiment can be useful for all-optical networks installed on sites, where any electrical devices are not allowed.

Bidirectional Fiber-Optic Multi-Channel Switch Embodiment

Another embodiment of the invention—fiber-optic multi-channel switch—is depicted in FIG. 11. In this embodiment, a multi-channel 1×N splitter/combiner 320 with N outputs is optically connected to N on-off switches 321 described above in such a way that each output of the splitter/combiner is in optical connection with one on-off switch. If all on-off switches are not activated, this multi-channel switch works as 1×N splitter/combiner. When the on-off switch is activated, it terminates signal transmission between the splitter/combiner input and the output where this on-off switch is installed. To switch the splitter/combiner input to any single output, all on-off switches have to be activated, except the single on-off switch, which is connected to this output. Therefore, all optical ways, where the on-off switches are activated, are closed; and only one way with not-activated on-off switch is opened.

The gages of this invention can be used for monitoring any physical parameter, such as pressure, temperature, structural movement, force, flow rate or other phenomena that may be converted into linear or rotational mechanical movement. The fiber-optic switch of this invention can be used in fiber-optical networks, such as telecommunication ones, all-optical data acquisition systems, or the data collecting system of the present invention.

From the foregoing exposition, those skilled in the fiber-optic sensing art will recognize that the invention can be embodied in forms different from those described in the foregoing exposition. Therefore, it is intended that this invention not be limited only to the embodiments shown or described in this specification. Rather, it is intended that the scope of this invention be construed in accordance with the appended claims.

### THE DRAWINGS

FIG. 1 represents the graph of function of specific attenuation F(r) from radius of bending taken at 1310-nm wavelength.

FIG. 2 (A, B, C and D) depicts the principles of fiber bending.

FIG. 3 diagrammatically depicts the object of the invention—a multi-channel single-mode fiber-optic gage data collecting system.

FIG. 4 diagrammatically depicts the modification of the multi-channel single-mode fiber-optic gage data collecting system that utilizes a multi-wavelength light source.

FIG. 5 diagrammatically depicts the modification of the multi-channel single-mode fiber-optic gage data collecting system that utilizes a photonic switch.

FIG. 6 diagrammatically depicts assembly of the object of this invention—a fiber-optic gage.

FIG. 7 depicts an embodiment of the gage for sensing gas or liquid pressure.

FIG. 8 depicts another embodiment of the bending device of the gage that utilizes the fiber bending around a fixed-radius shaft.

FIG. 9 depicts an embodiment of the gage for measuring temperature.

FIG. 10 depicts an embodiment of the object of this invention −1×2/2×1 fiber-optic switch.

FIG. 11 schematically depicts an embodiment of the object of this invention −1×N/N×1 fiber-optic switch.

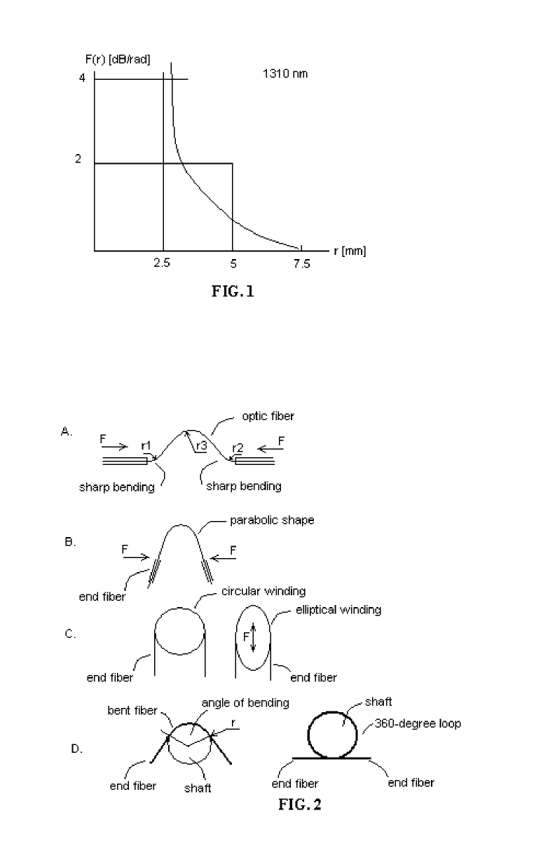

What is claimed is:

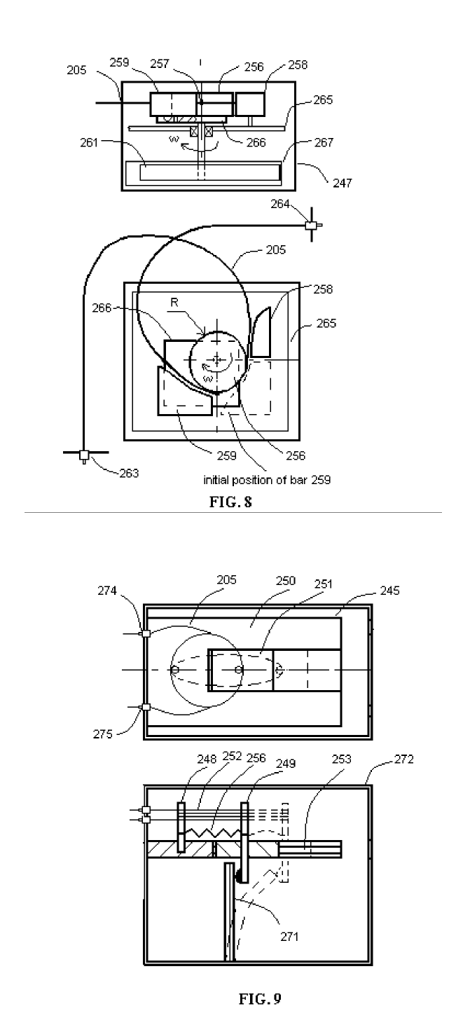

1. A fiber-optic gage comprising:
a length of optic fiber having an input end and an output end;
a first fiber-optic connector being optically coupled to said input end and a second fiber-optic connector being optically coupled to said output end;
a mechanical transducer, wherein said gage is affected by a measured physical phenomenon, said transducer converts said phenomenon into a mechanical movement;
wherein the improvement comprises:
said length of optic fiber, wherein said optic fiber is a single-mode optic fiber coiled as a circular multi-turn winding;
a bending device converting said movement into radial stretching of said winding that transforms the initially circular winding into elliptical one as depicted in FIG. 2C, FIG. 7 and FIG. 9, whereas said input end and said output end of said optic fiber are not disturbed by said bending and still tangentially positioned to said winding; therefore, said bending introduces attenuation of a single-mode light passing said optic fiber.

2. The gage of claim 1, with the bending device further comprising a cylindrical spring mandrel on which the multi-turn single-mode fiber-optic winding of claim 1 is applied and fixed as depicted in FIG. 7a, wherein said mandrel together with said winding changes the initially circular shape into elliptical one when said gage is affected by a measured physical phenomenon.

3. The gage of claim 1, wherein the bending device of claim 1 is modified to convert a measured phenomenon into bending a single-mode optic fiber around a permanent-radius shaft as depicted in FIG. 2D and FIG. 8, wherein said arc angle of said bending is in proportion to the measured phenomenon.

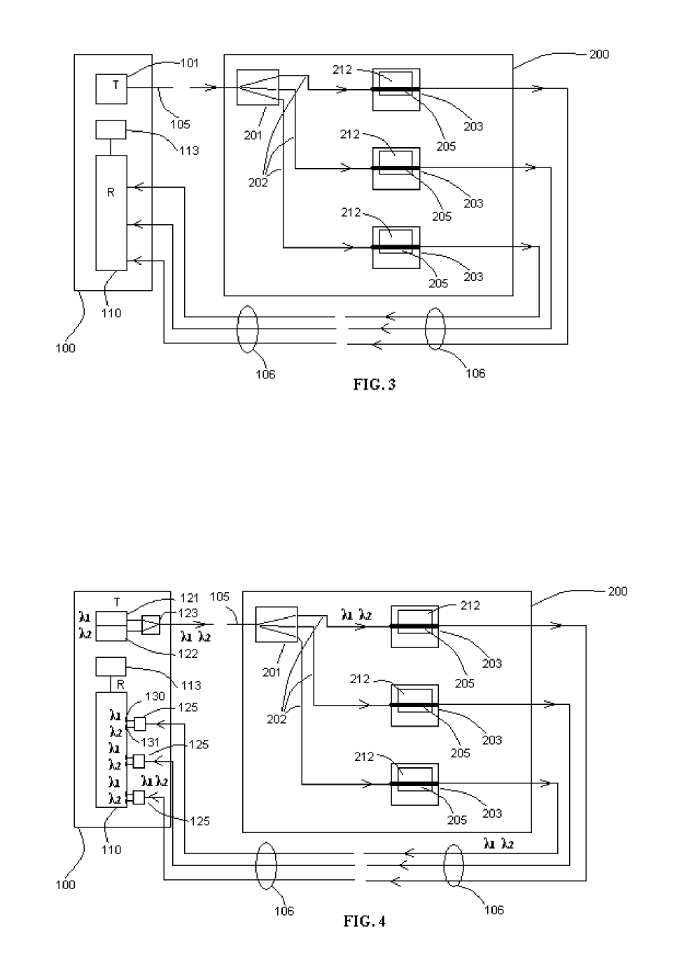

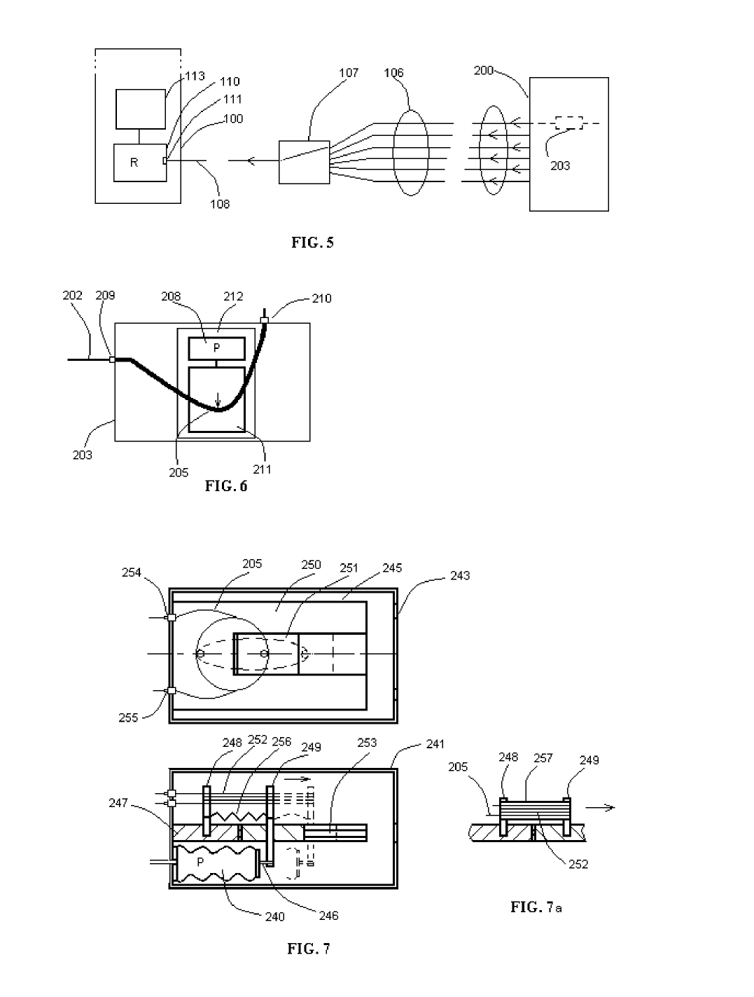

4. A multi-channel all-optical fiber-optic gage data collecting system depicted in FIG. 3 comprising:
one or more gages of claim 1;
a single-mode fiber-optic light source;
an input single-mode fiber-optical line being optically coupled to output of said light source;
a single-mode fiber-optic splitter having a single input end and one or more output ends, wherein input of said splitter is optically coupled to said light source via said input fiber-optical line;
one or more delivering single-mode fiber-optical lines optically coupled to said output ends of said splitter, wherein input end of each of said gages is in optical communication with said fiber-optic light source via said splitter, one of said delivering fiber-optical lines and said input fiber-optical line;
a number of output single-mode fiber-optical lines, wherein input end of each said output line is exclusively dedicated to and in optical connection with output end of each said gage;
one or more fiber-optic detectors exclusively dedicated to and in optical communication with output end of each said gage via one of said output single-mode fiber-optical lines;
a processor responsive to said detectors.

5. A multi-channel all-optical fiber-optic gage data collecting system depicted in FIG. 3 comprising:
one or more gages of claim 3;
a single-mode fiber-optic light source;
an input single-mode fiber-optical line being optically coupled to output of said light source;
a single-mode fiber-optic splitter having a single input end and one or more output ends, wherein input of said splitter is optically coupled to said light source via said input fiber-optical line;
one or more delivering single-mode fiber-optical lines optically coupled to said output ends of said splitter, wherein input end of each of said gages is in optical communication with said fiber-optic light source via said splitter, one of said delivering fiber-optical lines and said input fiber-optical line;
a number of output single-mode fiber-optical lines, wherein input end of each said output line is exclusively dedicated to and in optical connection with output end of each said gage;
one or more fiber-optic detectors exclusively dedicated to and in optical communication with output end of each said gage via one of said output single-mode fiber-optical lines;
a processor responsive to said detectors.

6. The data collecting system of claim 4 modified as depicted in FIG. 4, wherein the modification comprising:
two or more single-mode fiber-optic light sources having different wavelengths;
a single-mode fiber-optic combiner having single output and number of inputs equal to the number of said light sources, wherein each said input is exclusively dedicated to each said light source and optically connected to outputs of said light sources; and said single output of said combiner is in optical communication with the input single-mode fiber-optic line of claim 4 to deliver multi-wavelength combined light signal to the splitter of claim 4;
one or more wavelength-demultiplexing units having single input and number of outputs equal to the number of said light sources, wherein each said unit, which is exclusively dedicated to each fiber-optic gage and in optical communication with this gage via one of the output optic lines of claim 4, receives said multi-wavelength combined light signal passed each fiber-optic gage, separates light signal of each wavelength and directs each separated signal to specific output of said unit;
two or more optic detectors optically connected to outputs of said wavelength-demultiplexing units, wherein total number of said detectors is equal to the number of wavelengths multiplied by the number of the gages, and each detector is exclusively dedicated to each wavelength of said combined light signal passed each fiber-optic gage.

7. The data collecting system of claim 4 modified as depicted in FIG. 5, wherein the modification comprising:
a multi-channel fiber-optic switch having single output and number of inputs equal to number of the output fiber-optical lines of claim 4, wherein each said input of said switch is optically coupled to one of said output fiber-optical lines and said single output of said switch is optically coupled to input end of a single fiber-optical line;
a single optic detector optically coupled to output end of said single fiber-optical line, wherein said fiber-optic switch sequentially connects each output optic line of claim 4 to said single fiber-optical line.

8. A method of calibrating and setup a multi-channel all-optical fiber-optic gage data collecting system depicted in FIG. 3 that contains a number of fiber-optic gages, said method comprising the step of:
measuring in decibels initial light signal attenuation introduced by each said gage at working wavelength, wherein said gages are not affected by a measured phenomenon;
measuring in decibels said light signal attenuation at different values of said measured phenomenon, for example, a gas pressure, affecting said gage to obtain a calibration table, wherein each measured value of said attenuation represents value of said phenomenon affecting the gage when measurement was preformed;
loading said calibration table in the memory of the processor 113 on FIG. 3;
measuring in decibels light signal attenuation introduced by each optic circuit of said data collecting system, wherein said optic circuit includes all optical elements connecting each said gage with the light source and the optic detector.

9. A method of measuring a physical phenomenon by means of a fiber-optic gage, wherein said measurement is performed by a multi-channel all-optical fiber-optic gage data collecting system depicted in FIG. 3, said method comprising the step of:
applying said measured phenomenon to said gages;
measuring in decibels total light signal attenuation of the optic circuit of said system including said gage, where the gage is installed;
subtracting the light signal attenuation of said optic circuit measured by the method of claim 8 from said measured total light signal attenuation;
processing said subtracted data to calculate value of said measured phenomenon by means of the gage calibration table of claim 8.

10. A method of measuring physical phenomenon by means of a fiber-optic gage, wherein said measurement is performed by the data collecting system depicted in FIG. 4 that contains a number of single-mode fiber-optic light sources having different wavelengths, said method comprising the step of:
applying measured phenomenon to said gage;
measuring in decibels total light signal attenuation introduced by optic circuit of said system for each wavelength separately, wherein said circuit includes said gage;
subtracting the light signal attenuation of said optic circuit measured by the method of claim 8 from said total light signal attenuation, wherein this operation is performed for each wavelength separately;
processing results of said operations to calculate the measured phenomenon by means of the calibration table of claim 8, wherein, to increase the measurement accuracy, absolute values of the attenuation measured for each wavelength and ratios of said attenuations are used to determine precise value of said measured phenomenon.

11. A bidirectional fiber-optic on-off switch comprising:
a bending device having a first low-radius cylindrical rod and a second low-radius cylindrical rod, wherein said first rod is the stationary one and said second rod has ability to be linearly shifted from a first position to a second position so extending the distance between said rods;
a length of single-mode optic fiber having input and output ends and freely coiled as a multi-turn circular winding around said first rod and said second rod being in said first position that is the closest to said first rod in such a way that does not attenuate a single-mode light signal passing said winding;
a first fiber-optic connector being optically coupled to said input end and a second fiber-optic connector being optically coupled to said output end;
a mechanical actuator, which, when said actuator is activated, moves said second rod from said first position to said second position extending the distance between said rods and causing said winding to shift its shape from circular to elliptical one, wherein said shape shifting highly attenuate said light signal passing said winding that completely terminates transmission of said signal.

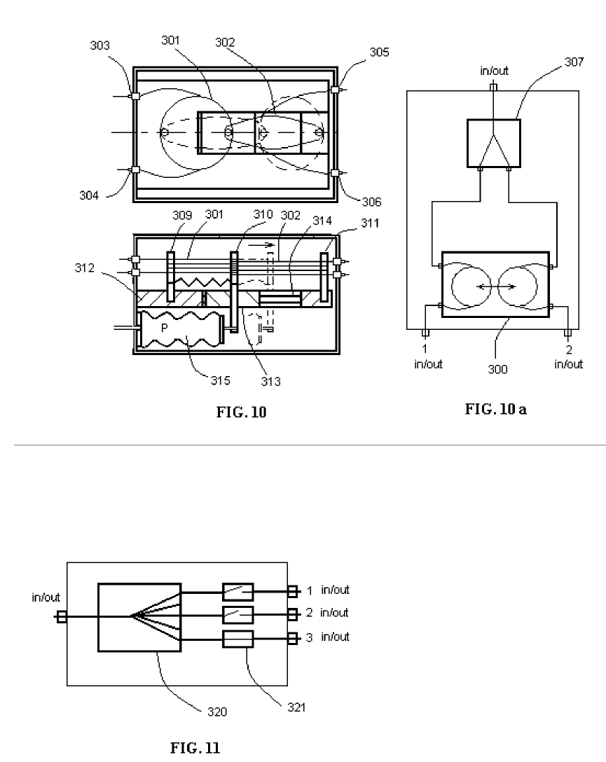

12. A bidirectional fiber-optic switch connecting single input with two outputs comprising:
a bending device having a first low-radius cylindrical rod, a second low-radius cylindrical rod and a third low-radius cylindrical rod as depicted in FIG. 10, wherein said first rod and said third rod are the stationary ones, and said second rod has ability to be linearly shifted in two positions between said first and third stationary rods;
the length of optic fiber of claim 11 having input and output ends and freely coiled as a multi-turn circular winding around said first rod and said second rod being in said first position that is the closest to said first rod in such a way that does not attenuate a single-mode light signal passing said winding;
a second length of optic fiber having input and output ends, wherein said second winding is an elliptical one tightly pulled over said second and third rods in such a way that said second winding highly attenuates a light signal running in said winding so completely terminating transmission of said signal;
a mechanical actuator, which, when said actuator is activated, moves said second rod in said second position closest to said third rod in such a way that causes said first winding to change its shape from circular to elliptical one and said second winding to change its shape from elliptical to circular one, therefore, said second winding, which is now circular, does not attenuate said light signal running in said second winding, and said first winding, which is now elliptical, highly attenuates the light signal running in said first winding so completely terminating transmission of said signal;
a first fiber-optic connector being optically coupled to said input end of said first winding and a second fiber-optic connector being optically coupled to said output end of said first winding;
a third fiber-optic connector being optically coupled to said input end of said second winding, a forth fiber-optic connector being optically coupled to said output end of said second winding, a fifth optic connector;
a fiber-optic splitter/combiner having single input, a first output and a second output, wherein said single input is optically coupled to said fifth optic connector, said first output is optically coupled to said first optic connector and said second output is optically coupled to said third optic connector as depicted in FIG. 10a; therefore, when said actuator is not activated, said switch provides bidirectional optical communication between said fifth connector and the second optic connector, whereas optical communication between said fifth connector and said forth connector is terminated, and when said actuator is activated, said switch provides bidirectional optical communication between said fifth connector and said forth connector, whereas optical communication between said fifth connector and said second optic connector is terminated.

13. A multi-channel fiber-optic switch comprising:
two or more on-off switches of claim 11;
a fiber-optic splitter/combiner having a single input and two or more outputs, wherein the number of the on-off switches of claim 11 is equal to the number of said outputs and each said switch of claim 11 is in optical connection and exclusively dedicated to each said output of said splitter/combiner as depicted in FIG. 11; therefore, when the actuator of any said switch of claim 11 is not activated, said switch provides bidirectional optical communication between said single input of said fiber-optic splitter/combiner and the second fiber-optic connector of said switch of claim 11.
